(19) United States
(12) Patent Application Publication
(10) Pub. No.: US 2008/0032005 A1
(43) Pub. Date: Feb. 7, 2008

(54) Layered Snacks And Ready-To-Eat Cereals And Methods Related Thereto

(76) Inventors: Bin Fu, Battle Creek, MI (US); Mark Holdridge, Richland, MI (US)

Correspondence Address: Kristine H. Johnson;Dickinson Wright PLLC, Ste. 2000, 38525 Woodward Ave., Bloomfield Hills, MI, 48304-2970, US

(21) Appl. No.: 11/832,194

(22) Filed: Aug. 1, 2007

Related U.S. Application Data
(60) Provisional application No. 60/835,006, filed on Aug. 2, 2006.

(51) Int. Cl. A21D 13/00; A21D 6/00

(52) U.S. Cl. 426/94; 426/502

(57) ABSTRACT

The present invention is in the field of layered food products and processes for making them. The present invention provides food items with improved crispy and non-abrasive texture and more abundant flavor, as well as industrially-efficient and cost-effective processes for making food items with the improved crispy and non-abrasive texture and more abundant flavor.

### FIELD OF THE INVENTION

The present invention is in the field of layered snacks and ready-to-eat (RTE) cereals, and processes for making them. The present invention provides food items with improved crispy yet non-abrasive texture, as well as industrially-efficient and cost-effective processes for making food items with the improved crispy yet non-abrasive texture. Moreover, the present invention provides food items and processes for making them with more abundant flavor.

### BACKGROUND OF THE INVENTION

A traditional method of making snack foods and RTE cereals from whole wheat includes shredding wheat and forming the wheat into snacks or RTE cereals. More specifically, such methods include partially-cooking whole wheat berries and subsequently breaking the wheat berries. The partially cooked wheat berries are then fed to a shredding mill. The shredding mills include a first roller and a second roller disposed near the first roller. As the first roller and the second roller rotate, the partially cooked berries are fed between the first roller and the second roller and are broken into wiry strings. The rollers of the shredding mill also serve to align the strings into a thin layer. The thin layer of aligned strings is subsequently layered with other such string layers. The formation is then compressed into a mat. A mat can also be formed by folding the thin layer on itself. Regardless how it is formed, the mat is then cut into pieces and the pieces are baked into a wheat snack or a RTE cereal. Triscuits brand cracker is an example of a snack made from such technology. Shredded Wheats brand breakfast cereal is an example of a RTE cereal made from such technology. Other products with similar processing techniques include Chex brand and Crispix® ready-to-eat cereals.

The prior snacks and RTE cereals that are made from the previous technology have the drawback that when the wheat strings separate during consumption, the individual strands have an undesirable texture to some consumers, and are also perceived as abrasive to some consumers. Such shredded products are also, often bland, with the primary flavors being salt and wheat.

It is desirable to manufacture a snack food or a RTE cereal made from whole wheat and/or other grains such that the food has the similar or better nutritional value of a shredded wheat snack or RTE cereal and has a non-abrasive texture. Moreover, it is desirable to provide consumers with crisp, flavored snacks and RTE cereals with dual textures, such as those described herein.

### SUMMARY OF THE INVENTION

The present invention provides layered food products, comprising at least two grain-based dough sheets, each sheet having a smooth continuous surface and a grooved continuous surface; and wherein said sheets are layered, so as to form a layered food product. Preferred are those layered food products, wherein the layered food product is a baked layered food product. Those layered food products, wherein said dough sheets comprise coarse ground wheat are preferred examples of the baked food products. In one such example, those baked food products, wherein the dough sheets comprise two dough sheets each having the smooth surfaces on the exterior and the grooved surfaces on the interior of the layered food product are included, preferably with flavorant in contact with the grooved surfaces and/or flavorant in contact with the smooth surfaces. Moreover, baked food products such as described, with cut and/or crimped edges are provided, preferably those that are appropriate size as a hand-held snack and/or a ready-to-eat cereal.

Also provided are methods to make the layered food products, comprising: providing at least two grain-based dough sheets, each sheet having a smooth continuous surface and a grooved continuous surface; and layering said sheets, so as to form a layered food product. Preferred are methods, wherein the sheets are formed by passing grain-based dough through a set of at least two rollers, at least one of the rollers having a groove-forming surface, and at least one of the rollers having a smooth-forming surface, so as to form sheets having a smooth continuous surface and a grooved continuous surface. Preferably, the rollers are positioned such that each dough sheet presents its smooth surface on the exterior and its grooved surface on the interior of the layered food product. In particular, those methods wherein each set of rollers are positioned in conjunction with a conveyor, so as to facilitate layering and transporting of the dough sheets are included. Methods which further comprise cutting the continuous layered food product are preferred. Also included are methods wherein the cut food product is decoratively crimped, so as to retain the grooves on the interior surfaces but not on the edges. Methods wherein the crimped, cut, layered food product is subsequently baked are also included. There is also included the preferred method wherein the grain-based dough is fed through the rollers by sending dough in the form of kibbles to the roller sets, so as to form the dough sheets. Moreover, methods which include providing flavorants on the interior and/or the exterior of the layered food product are included.

Products made by the process described herein are also included.

### Definitions

“Baked” as used herein has the meaning that is generally accepted by those skilled in the art of food processing, but also includes those processes, such as toasting or drying, that accomplish the same moisture-reducing and crisping result. Therefore, for the purposes of the present invention, expansion heating, puffing, atmospheric variations, and other techniques which cause sudden or slow loss of moisture of the food product are within the scope of the term “baking.” “Baking” is intended to include optional pre-drying of dough and subsequent toasting.

“Coarse-ground” as used herein means breaking the reference particle into smaller pieces than originally found, and is intended to have the meaning that is generally accepted by those in the art of food processing, but also includes all grinds other than fine or super fine flour, as those words are interpreted by those in the art of food processing.

“Crimped” as used herein has the meaning that is generally accepted by those skilled in the art of food processing, including simple cutting but also decorative trim at the cutting site.

“Dough” as used herein means any mixture of ingredients that are capable of forming a cohesive mass that can be sheeted in the described manner. The term does not imply leavening agents as a necessary feature. Indeed, the present invention preferably uses doughs without leavening, although some leavening may be used in other embodiments.

“Grain-based” as used herein means any dough that contains grain as a primary ingredient. For instance, “grain-based” includes doughs made from whole grains or refined grains, coarse-ground or finely or super finely ground whether blended with other grains or with other ingredients or not.

“Grooved continuous surface” as used herein means that the primary structural feature is ridges or other raised topology, so as to create the resulting grooves, even if a portion of the surface is flat or smooth. For instance, “grooved continuous surface” includes doughs with continuous ridges, dashed ridges, wavy ridges, concentric circles of ridges, small dots of raised dough, small squares of raised dough, and other similar configurations. The directionality and height of the ridges may vary, except to the extent that the grooves present on the grooved surface may not prevent smoothness of the smooth continuous surface, nor may the height of the ridges prevent layering.

“Layered” as used herein is intended to have the meaning that is generally accepted by those in the art of food processing, including many processes that are known to be a sub-set of the term “layered” such as laminating, folding, stacking, etc. “Layered” does not imply any percentage of contact between sheets other than that at least one surface of one sheet is at least partially in contact with at least one surface of another sheet. In addition, “layered” does not imply ultimate flatness of the food product; twisted, shaped or otherwise physically distorted from flat food products can also be “layered” for the purposes of this description.

“Sheet” or “Sheets” or “Sheeting” as used herein includes the meaning commonly-accepted in the art of cracker technology, as well as techniques well-known in the art of cereal technology, such as extrusion. “Sheet” and “sheets” are intended to mean a piece(s) of dough that is capable of being layered as described herein. “Sheeting” is intended to mean forming a piece(s) of dough capable of being layered as described herein.

“Smooth continuous surface” as used herein means that the primary structural feature is a relatively flat topology that is substantially free of visible holes, so as to create the resulting smooth surface, even if the surface has wheat berries, fiber particulates or other particles making the surface slightly bumpy. For instance, “smooth continuous surface” includes dough sheets with flavors and/or inclusions that can be pressed through rollers so long as the flavors and/or inclusions do not create rips or holes in the surface, as well as dough sheets that have been topped with crushed candy, chocolate, herbs, etc., except to the extent that any inclusions, toppings, etc. prevent formation of ridges and the resulting grooves on the grooved continuous surface or prevent layering.

### BRIEF DESCRIPTION OF THE DRAWINGS

Other advantages of the present invention will be readily appreciated, and better understood by reference to the following detailed description, especially when considered in connection with the accompanying examples and drawings wherein:

FIG. 1 is a top perspective view of a layered food of the present invention;

FIG. 2 is an exploded internal view of a layered food of the present invention with two sheets with grooved surfaces showing; and

FIG. 3 is a schematic of a production line with two shredding mills.

### DETAILED DESCRIPTION OF THE INVENTION

The present invention provides layered snacks and layered RTE cereals and methods of making them. The dual- or multiple-layered snacks or cereals are preferably made from whole wheat and/or other grain materials such that the foods have the similar or better nutritional value of a wheat snack or shredded wheat and have a non-abrasive texture. More specifically, a snack of the present invention has a chip-like texture while a RTE cereal of the present invention has a light crunchy texture.

The present food products can be made from any grain-based dough. The necessary feature of the dough used in the present invention is that it is of such a consistency that it can be transferred through rollers to form a grooved surface and a smooth surface. Wheat is the most commonly used grain in snack food doughs and RTE cereals and the most desired grain by consumers. Therefore, wheat is the most preferred primary ingredient in the doughs useful in the present invention. However, wheat in combination with other grains provides a more complex flavor profile than wheat alone, and, therefore, a combination of wheat and other grains is most preferred for use in the dough component of the present invention. Such other grain materials can be either whole grains or grain components, such as germs or starches. Preferably, the dough ingredients therefore include partially-ground whole wheat, additional grain materials, water, and flavorings.

When wheat is used, the partially-ground wheat may be a pre-cooked wheat. Alternatively, the wheat may be raw cut wheat. Alternatively, other whole grains may be substituted for wheat. Pre-cooked wheat may be mixed with other ingredients without further cooking. Preferably, the pre-cooked wheat is pre-cooked bulgur wheat. The size of the preferred bulgur wheat particles is as follows: 0.1% through U.S. Screen Size #25, 30-35% through U.S. Screen Size #40, 35-40% through U.S. Screen Size #60, and 25-30% unscreened.

When raw cut wheat is used, the raw cut wheat may be attained by cutting raw wheat berries. The most preferred raw cut wheat is used in the present invention is classified as follows: 46-54% through U.S. Screen Size #10, 20-25% through U.S. Screen Size #12, 10-13% through U.S. Screen Size #14, and 14-22% unscreened.

Other whole grains, or any processing fractions of wheat or other grains, may be used in lieu of partially-ground or raw cut wheat, or in combination with such wheat, and can be, or be derived from, any of the following grains: maize, rice, barley, sorghum, millet, oats, rye, triticale, buckwheat, fonio, quinoa, teff, wild rice, amaranth, kaniwa, spelt, einkorn, emmer, and durum. Preferably, the doughs useful in the present invention are made from a grain or grains selected from the group consisting of: wheat and corn; wheat and brown rice; wheat and white rice; corn; white rice; brown rice; corn and white rice; corn and brown rice. Moreover, any of these grains may be combined with any other to produce a grain-based dough of the present invention.

Any component or combination of components of any of the above grains may be used to make such dough. For instance, whole grain, flour, germ, bran and starch may be used. The grind may be milled, meal, very coarse, coarse, fine, super fine or extra fine. Masa corn is the preferred type of corn selected, when corn is used in the dough. When additional grain ingredients are added to the dough, preferred supplementary grain materials include white rice, corn starch, wheat starch and wheat germ.

Cooking of the grains useful in the doughs is well-known in the art and includes heating the grain in contact with water or water vapor. This technique is often termed “pre-cooking” in cereal chemistry. The “pre-cooked” grain is then mixed with the other dough ingredients, for RTE cereals, formed into individual pieces and the dough is subsequently “pre-dried.” “Pre-drying” is often used prior to a “toasting” step in RTE cereal production, so as to reduce the moisture content of the dough from approximately 20-34% to approximately 10-14%. “Toasting” of the formed dough results in the desired crispness and color. The toasting step may also result in a “puffing” of the dough, which, when desired, may be accomplished by exposing the pre-dried dough to sudden high heat, causing the water in the dough to expand, and thereby also expanding the dough.

Preferred flavorings include salt, sugar, high fructose corn syrup, as well as any other sweet and/or savory flavorings. Preferred sweet flavorings include honey, honey flavor, molasses, malt extract, cinnamon, maple, chocolate, apple, nuts, and any combination thereof. Preferred savory flavorings include onion, garlic, horseradish, yeast, and any combination thereof.

Inclusions, such as sesame seeds, anise seed, rosemary leaves, nuts, candy bits, and the like are also useful in the present doughs. Inclusions of any sort are acceptable, provided that they can be sheeted such that the dough is able to be rolled through the rollers as described. Inclusions useful in the present doughs should be small enough to retain the structural integrity of the dough sheets, and not so big as to rip holes in the sheet, or puncture the grooved surface.

Water used in the present doughs is preferably at a temperature of 65-90° F. Doughs useful in the present invention preferably have 25-45% moisture prior to baking.

TABLE 1

| | Preferred |
|---|---|
| | Percent of Total |
| Ingredient | Dough |
| Wheat | 30-40 |
| Other grains | 50-60 |
| Water | 10-20 |
| Flavoring | 10-20 |

Toppings are optional ingredients in the food products of the present invention. Such toppings may be any know in the art, and include fat-based or sugar-based toppings. Any such toppings may be sweet or savory, or a combination of both. In addition, vitamins, minerals, or other nutrients may be added as a topping or in the dough.

Making dough. In the methods of the present invention, making dough is an optional step. Pre-made dough may be used, or dough can be made according to the present disclosure. Preferably, the flavorings for the dough are pre-mixed with water and then added to the other dough ingredients. Such pre-mixed flavorants mixed with a pre-cooked wheat ingredient dough are more preferred. Most preferred doughs for use in the present invention are those that are made with pre-mixed flavorants, at least one pre-cooked wheat ingredient, and other pre-cooked grains. However, doughs made from raw cut wheat that has been steamed in hot water are also desirable for use in the present invention. Such steamed raw cut wheat which further includes flavorings and additional raw grains are also preferred doughs for use in the present invention. A proper cooking step is needed if raw grains are used. A rotary cooker may optionally be used in the cooking process. Also, a dough useful in the present invention preferably is allowed to rest for 10-60 minutes, more preferably 15-30 minutes.

Forming sheets from dough. The present invention includes, in one embodiment, the use of industrial rollers to both sheet and form the grooved and smooth surface of the sheet. Feeding the dough into such apparatus in pieces, such as pieces commonly referred to as “kibbles” is preferred, particularly when an industrial process is used. Kibbling includes breaking the dough into generally round pieces which are 0.1 inch to 1 inch in diameter. Kibbles that are half inch in diameter or smaller are preferred.

Also preferred is the use of production line to form two measures of dough into two sheets of dough having a grooved surface and a smooth surface each. Such a production line may include a first shredding mill and a second shredding mill disposed above and aligned with the first shredding mill. In this instance, the term “shredding mill” is used to generically describe to those in the art the general structure of the apparatus, but since the rollers described herein do not effect a “shredding” per se, the term is not used to describe the result. In particular, both shredding mills include a grooved roller and a smooth roller, and therefore would not result in “shredding” but rather a smooth surface and a grooved surface. When dough is passed through these rollers, the grooved roller presents a finely grooved surface extending circumferentially around the grooved roller and the smooth roller presents a smooth surface extending circumferentially around the smooth roller. Preferably, the method includes feeding a measure of dough to the first shredding mill and, simultaneously, feeding a second measure of dough to the second shredding mill. In such an example, the first shredding mill forms an upper dough sheet and the second shredding mill forms a lower dough sheet, each sheet having a grooved surface and a smooth surface. Preferably, the grooved roll is heated to approximately 100-130° F.

The grooves of the grooved surface, pre-bake, optimally measure 0.008 inches to 0.024 inches in width and 0.006 inches to 0.020 inches in depth, however, any grooved surface with grooves that are up to 0.004 inches to 0.048 inches in width and 0.004 inches to 0.040 inches in depth will be operable in the present invention. In other words, the ridges that form the grooves are preferably 0.008 inches to 0.096 inches apart, more preferably 0.016 inches to 0.048 inches and most preferably 0.024 inches to 0.040 inches. The height of the ridges are preferably 0.004 inches to 0.040 inches, more preferably 0.008 inches to 0.032 inches and most preferably 0.012 inches to 0.016 inches.

The sheets of the present invention can be of any thickness, so long as the layers remain crispy and without burn spots when baked, and so long as the sheets remain substantially free of holes. To modify the thickness of the dough sheets, the rollers can be arranged closer together, for thin sheets, or farther apart, for thicker sheets. The dough sheets, are preferably 0.016 inches to 0.048 inches in thickness prior to baking, more preferably 0.020 inches to 0.040 inches in thickness, and most preferably 0.024 inches to 0.032 inches in thickness.

To create dough sheets with the specifications described, rollers may be designed and manufactured according to standard machining techniques. Ridges may be altered according to the preferred result, and such manipulations are within skill of the art.

Layering dough sheets. Depending upon the desired texture, the dough sheets may be aligned with one another such that both smooth surfaces of the sheets face inwardly, or such that both grooved surfaces of the sheets face inwardly, or such that the grooved surface of one sheet faces inwardly and the smooth surface of the other sheet faces inwardly. Additional mills can be installed on the production line to produce the third sheet, fourth sheet, etc. Alternatively, a laminator can be used to create multiple layers from a single sheet. The exemplified method further includes forming dual sheets or multiple sheets via lamination.

For the purposes of the present invention, any combination of doughs, whether by flavor, texture or appearance are within the scope. For instance, one sheet of dough may be chocolate flavored and dark in color, and the second sheet of dough may be cinnamon flavored and light in brown color. Moreover, stripes of color flavor, and/or texture or designs of color, flavor, and/or texture are within skill of the art. To effect such designs, one may use split feeding tubes or split hoppers, if on an industrial line.

Flavorants between layers. At the layering step, there is an optional opportunity to season or fill the void or voids between the layers. Such flavorants may take the form of a dry seasoning blend, such as a taco seasoning, or a lubricious, low water activity filling, such as peanut butter. Such a filling may be applied by means known in the art and include dry deposition, spraying and extruding. Quantities of ingredients are known in the art and may be any that are desirable, so long as the sheets have the ability to substantially maintain a crimp around the perimeter of layered dough, and so long as the layered food products retain the crisp texture.

Cutting sheets. While cutting sheets is technically an optional step in the processes of making the layered food products, when an industrial method is used, cutting will be commercially ideal for packaging the product. However, any such cutting can include a wide variety of designs and configurations, and preferably includes a scrap-less design, i.e. no web return. Circle, square, rectangle, hexagon shapes are preferred. Often, a tessellation of cartoon characters will be desirable for children's snacks, and that embodiment is within the scope of the present invention.

Crimping. While crimping is also optional, and often simultaneous with cutting of layered sheets, it is not a necessary step, nor is it necessary for crimping to be simultaneous. Crimping may be accomplished after or before cutting, depending on the design desired. For the purposes of the present invention, however, it is necessary, when crimping is desired, to allow some of the layered product to remain only loosely layered, so as to allow at least a portion of the grooved surfaces to remain grooved.

Baking. Baking the food product results in the most preferred food product of the present invention. However, since the intermediate, unbaked food product is inventive, and could be baked at home by the retail outlet or by the consumer, it is therefore an optional step in the present methods. The most preferred method, despite the possibility of distributing a ready-to-bake product, is to pre-bake prior to distribution. In an industrial embodiment of such a method, baking can occur at any temperature and time that will result in a crisping of the product and a moisture level of 0.5-5%, preferably 2-3%.

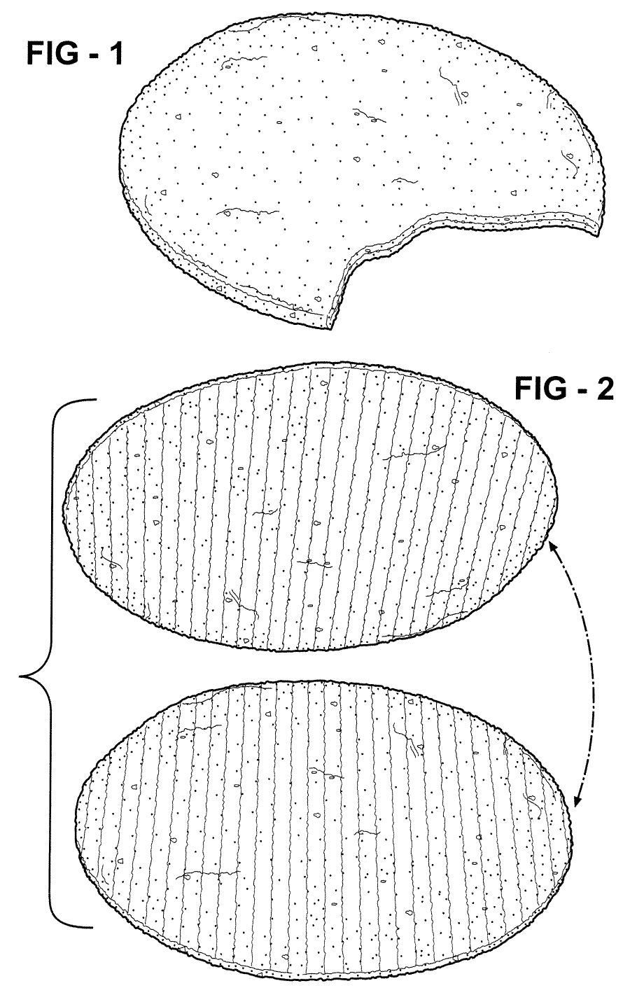

Referring to the Figures, wherein like numerals indicate corresponding parts throughout the several views, a layered food of the present invention 20 is generally shown in FIGS. 1-3.

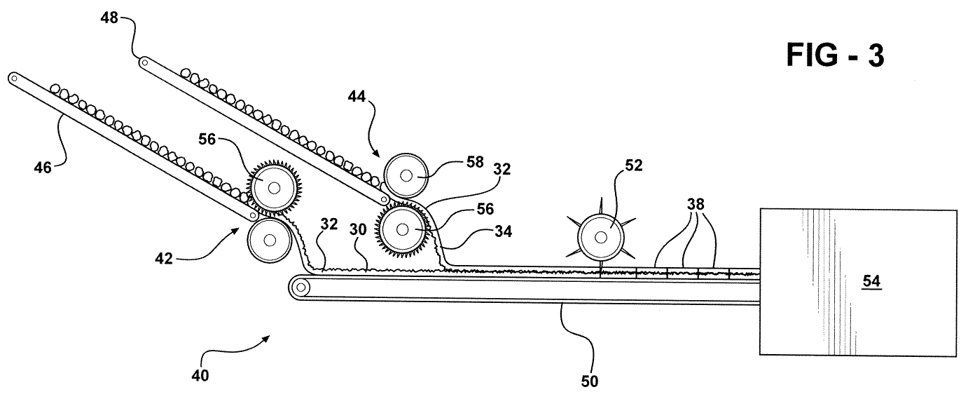

An exemplified food of the present invention 20 includes a plurality of layers joined to one another and, as shown in FIG. 3, more preferably includes a first layer 24 and a second layer 26 joined to the first layer 24. The first layer 24 and the second layer 26 each have a smooth side 28 and a grooved side 30, which can be seen in FIG. 4. The first layer 24 and the second layer 26 may be aligned such that the grooved side 30 of each layer faces inwardly and the smooth side 28 of each layer faces outwardly. Alternatively, the first layer 24 and the second layer 26 may be aligned such that the grooved side 30 of each layer faces outwardly and the smooth side 28 of each layer faces inwardly. Alternatively, the first layer 24 and the second layer 26 may be aligned such that the smooth side 28 of the first layer 24 faces outwardly and the grooved side 30 of the second layer 26 faces outwardly.

With reference to the specific embodiment shown in the figure, dough is formed into a plurality of mats 32 and is preferably formed into an upper mat 34 and a lower mat 36. The mats 32 are overlayed such that each mat forms a layer of the food product 20 when baked. The overlayed mats 32 are cut into pieces 38 and crimped together around a perimeter of the pieces 38 and the pieces are baked. The dough preferably has a consistency such that the mats 32 may be crimped together around the perimeter of the pieces 38 and remains separated inside the crimped perimeter.

An example of a production line 40 used to form the dough into food products of the present invention 20 is shown in FIG. 5. The production line 40 includes a first shredding mill 42, and a second shredding mill 44, a first feeding tube 46 aligned with the shredding mill 42, a second feeding tube 48 aligned with the shredding mill 44, a conveyor 50 disposed below the shredding mills 42, 44, a rotary cutter 52 disposed over the conveyor 50, and an oven 54.

More specifically, the shredding mill 42 and the shredding mill 44 are used to form the dough into the lower mat 36 and the upper mat 34, respectively. Each shredding mill includes a finely grooved roller 56, a smooth roller 58, and a scrape-off knife (not shown). The rollers 56, 58 are generally cylindrical. The grooved roller 56 presents a grooved surface extending circumferentially around the grooved roller 56. The grooved surface defines fine grooves that extend in a circumferential direction around the circumference of the grooved roller 56. The smooth roller 58 presents a smooth surface extending circumferentially around the smooth roller 58.

The dough is kibbled and is transferred to the first feeding tube 46 and the second feeding tube 48. The first feeding tube 46 feeds kibbled dough to the shredding mill 42 and the second feeding tube 48 feeds kibbled dough to the shredding mill 44. The shredding mill 42 forms the kibbled dough from the first feeding tube 46 into the lower mat 36 and deposits the lower mat 36 onto the conveyor 50. The shredding mill 44 forms the kibbled dough from the second feeding tube 48 into an upper mat 34 and deposits the upper mat 34 onto the lower mat 36. The scrape-off knife of the shredding mill 42 is stationary and is disposed adjacent to the grooved roller 56 of the shredding mill 42 and removes the lower mat 36 from the grooved roller 56 of the shredding mill 42 as the grooved roller 56 rotates. Likewise, the scrape-off knife of the shredding mill 44 is stationary and is disposed adjacent to the grooved roller 56 of the shredding mill 44 and removes the upper mat 34 from the grooved roller 56 of the shredding mill 44 as the grooved roller 56 rotates. Alternatively, additional shredding mills and feed tubes may be added such that more than two mats may be deposited onto the conveyor 50. Specifically, the additional shredding mill would form dough into additional dough mats.

When the shredding mill forms the kibbled dough into a mat, the grooved roller 56 forms the grooved side 30 of the mat and the smooth roller 58 forms the smooth side 28 of the mat. Flavorings may be applied to the layers and the grooved sides 30 provide a larger area to adhere flavorings. An optional depositor is schematically shown at 70, positioned between the two mills 42 and 44 to add, for example, flavor seasoning, filling, etc. between the layers 34, 36. Another option would be a topical depositor shown schematically at 72 for applying flavors, seasoning, etc. to the top of the layer 34. The smooth outside surface in combination with the grooved inside surface also creates a desirable texture.

As shown in FIG. 5, preferably the grooved roller 56 of the shredding mill 42 may be disposed to the right side of the smooth roller 58 of the shredding mill 42 and the grooved roller 56 of the shredding mill 44 may be disposed to the left side of the smooth roller 58 of the shredding mill 44. In such a configuration, the shredding mill 42 deposits the lower mat 36 on the conveyor 50 such that the grooved side 30 of the lower mat 36 faces upwardly and the smooth side 28 of the lower mat 36 faces downwardly. Likewise, shredding mill 44 deposits the upper mat 34 onto the lower mat 36 such that the grooved side 30 of the upper mat 34 faces downwardly toward the grooved side 30 of the lower mat 36 and the smooth side 28 of the upper mat 34 faces upwardly. When the upper mat 34 and the lower mat 36 are aligned such that the grooved side 30 of each mat 34, 36 faces inwardly, the grooves trap air between the mats 34, 36 such that the mats 34, 36 remain separated inside the perimeter when the mats 34, 36 are crimped together along the perimeter of the pieces 38. In other words, when baked, the grooved sides 30 of the layers 24, 26 define a void or voids between the layers 24, 26 of the food product snack 20. The air pocket(s) allows the mats 34, 36 to crisp on both surfaces such that each of the plurality of layers is crisp when baked.

Alternatively, the grooved roller 56 of the shredding mill 42 may be disposed to the left side of the smooth roller 58 of the shredding mill 42 and the grooved roller 56 of the shredding mill 44 may be disposed to the right side of the smooth roller 58 of the shredding mill 44. In such a configuration, the shredding mill 42 deposits the lower mat 36 onto the conveyor 50 such that the grooved side 30 of the lower mat 36 faces downwardly and the smooth side 28 of the lower mat 36 faces upwardly. Likewise, the shredding mill 44 deposits the upper mat 34 onto the lower mat 36 such that the smooth side 28 faces downwardly toward the smooth side 28 of the upper mat 34 and the grooved side 30 of the upper mat 34 faces upwardly.

Alternatively, the grooved roller 56 of the shredding mill 42 may be disposed to the right side of the smooth roller 58 of the shredding mill 42 and the grooved roller 56 of the shredding mill 44 may be disposed to the right side of the smooth roller 58 of the shredding mill 44. In such a configuration, the shredding mill 42 deposits the lower mat 36 onto the conveyor 50 such that the smooth side 28 of the lower mat 36 faces downwardly and the grooved side 30 of the lower mat 36 faces upwardly. Likewise, the shredding mill 44 deposits the upper mat 34 onto the lower mat 36 such that that the smooth side 28 of the upper mat 34 faces downwardly toward the grooved side 30 of the upper mat 34 and the grooved side 30 of the upper mat 34 faces upwardly.

The conveyor 50 transfers the upper mat 34 and the lower mat 36 below the rotary cutter 52. The rotary cutter 52 cuts the mats 32 into pieces 38. The pieces can be circle, square, rectangle, hexagon, and the like. The conveyor 50 then transfers the pieces 38 to the oven 54. The oven 54 bakes the pieces 38 into food product 20. Additional toppings may be added to the pieces 38 prior to baking and may also be applied to the food products 20 after baking.

The exemplified method further includes matting the kibbled dough into dough mats 32. Specifically, the method further includes feeding the dough pieces to the shredding mills 42, 44. More specifically, the method further includes transferring the dough pieces onto the first feeding tube 46 and the second feeding tube 48. The dough pieces transferred to the first feeding tube 46 are fed by the first feeding tube 46 to the shredding mill 42 and the shredding mill 42 mats the dough pieces into the lower mat 36. Likewise, the dough balls transferred to the second feeding tube 48 are fed by the second feeding tube 48 to the shredding mill 44 and the shredding mill 44 mats the dough pieces into the upper mat 34. Likewise, if the production line 40 includes additional feeding tubes and additional shredding mills the dough pieces transferred to the additional feeding tubes are fed by the additional feeding tubes to the additional shredding mills and the additional shredding mills mat the dough pieces into mats 32. Thus, multiple-layered food products can be produced.

The exemplified method further includes finely grooving a side of each dough mat 32 to form the grooved side 30 and simultaneously smoothing a side of the dough mat to create the smooth side 28. Specifically, when the dough pieces are flattened between the grooved roller 56 and the smooth roller 58, the grooved roller 56 forms a grooved side 30 of the dough mat and the smooth roller 58 forms a smooth side 28 of the dough mat.

The exemplified method further includes removing the dough mat from the shredding mill. Specifically, the method includes scraping the grooved roller 56 with the scrape-off knife to remove the dough mat from the grooved roller 56 as the grooved roller 56 rotates. More specifically, as the dough is flattened between the grooved roller 56 and the smooth roller 58, the dough adheres to the grooved roller 56. The grooved roller 56 is heated to reduce the adherence of the dough to the grooved roller 56 and the scrape-off knife removes the dough from the grooved roller 56.

The exemplified method further includes depositing the dough mats 32 onto the conveyor 50. Specifically, the method further includes depositing the lower mat 36 onto the conveyor 50 and depositing the upper mat 34 onto the lower mat 36. More specifically, when the lower dough mat is removed from the grooved roller 56 of the shredding mill 42, the lower dough mat 36 is deposited onto the conveyor 50. When the upper dough mat 34 is removed from the grooved roller 56 of the shredding mill 44, the upper dough mat 34 is deposited onto the lower mat 36.

The exemplified method further includes positioning the upper mat 34 and the lower mat 36 such that the grooved side 30 of each mat 34, 36 faces inwardly and the smooth side 28 of each mat faces outwardly. Alternatively, the method includes positioning the upper mat 34 and the lower mat 36 such that the grooved side 30 of each mat 34, 36 faces outwardly and the smooth side 28 of each mat 34, 36 faces inwardly. Alternatively, the method includes positioning the upper mat 34 and the lower mat 36 such that the grooved side 30 of the upper mat 34 faces inwardly and the smooth side 28 of the lower mat 36 faces inwardly toward the grooved side 30 of the upper mat 34.

The exemplified method further includes transferring the dough mats 32 on the conveyor 50 to the rotary cutter 52. The method further includes cutting the mats 32 into pieces 38 with a rotary cutter 52.

The exemplified method further includes baking the dough pieces 38 into crispy food products 20. The method may also include applying oil and flavoring toppings to the crispy food product 20 before or after baking.

The process may also include adding a filling between the mats 32, 34, 36 prior to depositing the upper mat 34 onto the lower mat 36.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

### EXAMPLE 1

### Making, Sheeting, Layering and Baking a Grain-Based Dough

| Ingredients | Weight % |
|---|---|
| Cold Water | 32.00 |
| Fine Granulated Sugar | 8.00 |
| Malt Extract - Non Diastatic | 2.00 |
| 62 DE Corn Syrup | 2.00 |
| Honey | 1.60 |
| Granulated Salt | 0.50 |
| Honey Flavor | 0.50 |
| Extra Fine Bulgur Wheat | 30.00 |
| Fine Toasted Whole Wheat | 10.00 |
| Defatted Wheat Germ Granules | 5.00 |
| Masa Flour | 2.90 |
| Pre-cooked Brown Rice Flour | 2.90 |
| Modified corn starch | 2.60 |
| Total | 100.00 |

The first seven ingredients were mixed for three minutes on high. The remaining ingredients were added to the mixture of the first seven, and mixed on low for five minutes. The resultant dough was allowed to rest for 15 to 60 minutes before being formed into sheets having a smooth surface on one side and a grooved surface on the other side. The grooved surface was formed using rollers with ridge height of 0.012 inches, which resulted in a corresponding groove depth of 0.012 inches. Sheets were layered with grooved surfaces facing inward and baked at 400-450° F. for two to five minutes and a finished moisture of 2 to 3 percent.

### EXAMPLE 2

### “Original” Flavored Food Product Seasonings

| Original | |
|---|---|
| Base | 88.40 |
| Spray oil | 10.00 |
| Salt | 1.60 |

The baked, layered grain-based dough of Example 1 was sprayed with oil and sprinkled with salt on the exterior surfaces at the weight percentages above, so as to create a “plain” or “original” flavored food product.

### EXAMPLE 3

### “Ranch” Flavored Food Product Seasonings

| Ranch | |
|---|---|
| Base | 85.00 |
| Spray oil | 10.00 |
| Ranch Seasoning | 5.00 |

The baked, layered grain-based dough of Example 1 was sprayed with oil and sprinkled with ranch seasoning on the exterior surfaces at the weight percentages above, so as to create a “ranch” flavored food product.

### EXAMPLE 4

### “Brown Sugar Cinnamon” Flavored Food Product Seasonings

| Brown Sugar Cinnamon | |
|---|---|
| Base | 85.00 |
| Spray oil | 10.00 |
| Brown sugar cinnamon seasoning | 5.00 |

The baked, layered grain-based dough of Example 1 was sprayed with oil and sprinkled with brown sugar cinnamon seasoning on the exterior surfaces at the weight percentages above, so as to create a “brown sugar cinnamon” flavored food product.

### EXAMPLE 5

### Making, Baking, Sheeting and Layering a Grain-Based Onion Flavored Dough with Inclusions

| Ingredients | Weight % |
|---|---|
| Cold Water | 35.00 |
| Fine Granulated Sugar | 8.00 |
| High Fructose Corn Syrup | 2.00 |
| 62 DE Corn Syrup | 2.00 |
| Toasted Onion Powder | 0.30 |
| Extra Fine Bulgur Wheat | 30.00 |
| Fine Toasted Whole Wheat | 6.00 |
| Defatted Wheat Germ Granules | 3.30 |
| Masa Flour | 2.90 |
| Pre-cooked Brown Rice Flour | 2.90 |
| Modified Corn Starch | 2.60 |
| Crunchy Brown Rice* | 3.00 |
| Defatted Wheat Germ Granules* | 2.00 |
| Total | 100.00 |

The first five ingredients were mixed for three minutes on high. The next six ingredients were added to the mixture of the first three, and mixed on low for five minutes. The resultant dough was allowed to rest for 15 to 60 minutes. The rested dough was formed into sheets having a smooth surface on one side and a grooved surface on the other side. The grooved surface was formed using rollers with ridge height of 0.012 inches, which resulted in a corresponding groove depth of 0.012 inches. Sheets were layered with the last two ingredients (crunchy brown rice and defatted wheat germ granules) sandwiched between the layers and grooved surfaces facing inward. The layered food product was baked at 400-450° F. for two to five minutes and a finished moisture of 2 to 3 percent.

### EXAMPLE 6

### Making, Sheeting, Layering and Baking a Grain-Based Dough Using Raw Grains

| Ingredients | Weight % |
|---|---|
| Water | 31.80 |
| Cut Wheat | 45.50 |
| Rice | 11.40 |
| Corn Grits | 8.50 |
| Oat Bran | 2.80 |
| Total | 100.00 |

All of the ingredients were mixed and steam cooked at 2 psi for 40 to 50 minutes, then another 3 minutes at 17 psi. The cooked ingredients formed a dough and the dough was allowed to temper for 15 to 30 minutes. The tempered dough was then formed into sheets having a smooth surface on one side and a grooved surface on the other side. The grooved surface was formed using rollers with ridge height of 0.012 inches, which resulted in a corresponding groove depth of 0.012 inches. The sheets were layered with grooved surfaces facing inward. The layered food product was baked at 400-450° F. for two to five minutes and a finished moisture of 2 to 3 percent.

### EXAMPLE 7

### Making, Sheeting, Layering and Baking a Grain-Based Dough Using Raw Grains

| Ingredients | Weight % |
|---|---|
| Water | 31.80 |
| Cut Wheat | 28.60 |
| Toasted Whole Wheat Ground | 14.20 |
| Second Head Milled Rice | 14.20 |
| Corn Grits Coarse | 1.40 |
| Defatted Wheat Germ Granules | 2.80 |
| Sugar | 4.80 |
| Brown Granulated Sugar | 1.20 |
| Salt | 1.00 |
| Total | 100.00 |

The rice and corn grits, in the amounts above, were pre-steamed for twenty minutes at 15 psi. All of the other ingredients, in the amounts above, were mixed with the rice and corn grits, along with the water. The resultant mixture was cooked at 17 psi for four minutes, and then at 2 psi for 50 minutes. The cooked ingredients formed a dough and the dough was allowed to temper for 15 to 30 minutes. The tempered dough was then formed into sheets having a smooth surface on one side and a grooved surface on the other side. The grooved surface was formed using rollers with ridge height of 0.012 inches, which resulted in a corresponding groove depth of 0.012 inches. The sheets were layered with grooved surfaces facing inward. The layered food product was baked at 400-450° F. for two to five minutes and a finished moisture of 2 to 3 percent.

### EXAMPLE 8

### Making, Sheeting, Layering and Baking a Grain-Based Dough Without Wheat

| Ingredients | Weight % |
|---|---|
| Water | 9.50 |
| Second Head Milled Rice | 40.50 |
| Corn Grits Coarse | 27.50 |
| Rice Flour | 9.00 |
| Oat Bran | 4.50 |
| Defatted Wheat Germ Granules | 4.20 |
| Sugar | 4.00 |
| Salt | 0.80 |
| Total | 100.00 |

The rice and corn grits, in the amounts above, were pre-steamed for twenty minutes at 15 psi. All of the other ingredients, in the amounts above, were mixed with the rice and corn grits, along with the water. The resultant mixture was cooked at 17 psi for four minutes, and then at 1 psi for 40 to 50 minutes. The cooked ingredients formed a dough and the dough was allowed to temper for 15 to 30 minutes. The tempered dough was then formed into sheets having a smooth surface on one side and a grooved surface on the other side. The grooved surface was formed using rollers with ridge height of 0.012 inches, which resulted in a corresponding groove depth of 0.012 inches. The sheets were layered with grooved surfaces facing inward. The layered food product was baked at 400-450° F. for two to five minutes and a finished moisture of 2 to 3 percent.

### EXAMPLE 9

### Layered Food Products with Sugar Frosting Coating

A 75 brix solution of sucrose and water was prepared. The solution was heated to 230° F. to raise the brix to approximately 80 brix. The syrup was applied to pieces of layered, baked food product in a coating drum via spray application. The application rate was from 10 to 50 percent syrup to base, depending on the batch. The coated pieces were removed from the coating drum and placed in a dryer. The coated pieces were then dried at approximately 200° F. for approximately 30 minutes so as to lower the moisture to below 3 percent in the finished food.

### EXAMPLE 10

### Layered Food Products with Fondant Frosting Topping

Eighty-seven and one-half percent by weight powdered sugar was combined with 12% water and 0.5% gelatin in a double boiler pan. The combination was heated to approximately 160° F. The heated combination was applied to the tops of the baked, layered food pieces at approximately 10 to 20% application rate, via spray application. The topped food pieces were allowed to cool, so as to allow the gelatin to set the fondant.

1. A layered food product, comprising:
at least two grain-based dough sheets, each sheet having a smooth continuous surface and a grooved continuous surface;
wherein said sheets are layered, so as to form a layered food product.

2. A layered food product of claim 1, wherein the layered food product is a baked layered food product.

3. A layered food product of claim 2, wherein said dough sheets comprise at least one grain selected from the group consisting of: wheat, maize, rice, barley, sorghum, millet, oats, rye, triticale, buckwheat, fonio, quinoa, teff, wild rice, amaranth, kaniwa, spelt, einkorn, emmer, and durum.

4. A layered food product of claim 2, wherein said dough sheets comprise at least one grain selected from the group consisting of: coarse-ground wheat, masa corn; and rice.

5. A layered food product of claim 1, wherein said dough sheets comprise two dough sheets having the smooth surface on the exterior and the grooved surface on the interior of the layered food product.

6. A layered food product of claim 1, which further comprises flavorant in contact with at least one grooved surface.

7. A layered food product of claim 1, which further comprises flavorant in contact with at least one smooth surface.

8. A layered food product of claim 2, which is the size of a hand-held snack.

9. A layered food product of claim 8, which is a savory hand-held snack.

10. A layered food product of claim 2, which is the size of a ready-to-eat cereal.

11. A layered food product of claim 10, which is a sweet ready-to-eat cereal.

12. A method to make a layered food product, comprising:
providing at least two grain-based dough sheets, each sheet having a smooth continuous surface and a grooved continuous surface; and
layering said sheets, so as to form a layered food product.

13. A method of claim 12, wherein said first and second sheets are formed by passing grain-based dough through a set of at least two rollers, at least one of the rollers having a groove-forming surface, and at least one of the rollers having a smooth-forming surface, so as to form sheets having a smooth continuous surface and a grooved continuous surface.

14. A method of claim 13, wherein said rollers are positioned such that both dough sheets present the smooth surface on the exterior and the grooved surface on the interior of the layered food product.

15. A method of claim 14, which further comprises cutting the continuous layered food product.

16. A method of claim 15, which further comprises baking the layered food product.

17. A product made by the process of claim 13.

18. A product made by the process of claim 17.
